(19) United States
(12) Patent Application Publication
(10) Pub. No.: US 2010/0164990 A1
(43) Pub. Date: Jul. 1, 2010

(54) SYSTEM, APPARATUS, AND METHOD FOR AUGMENTED REALITY GLASSES FOR END-USER PROGRAMMING

(75) Inventor: Markus Gerardus Leonardus Maria Van Doorn, s-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,145

(22) PCT Filed: Aug. 15, 2006
(86) PCT No.: PCT/IB06/52812

§ 371 Date: Feb. 7, 2008

Related U.S. Application Data
(60) Provisional application No. 60/708,322, filed on Aug. 15, 2005.

(51) Int. Cl. G09G 5/00

(52) U.S. Cl. 345/633

(57) ABSTRACT

A system, apparatus, and method is provided for augmented reality (AR) glasses (131) that enable an end-user programmer to visualize an Ambient Intelligence environment having a physical dimension such that virtual interaction mechanisms/patterns of the Ambient Intelligence environment are superimposed over real locations, surfaces, objects and devices. Further, the end-user can program virtual interaction mechanisms/patterns and superimpose them over corresponding real objects and devices in the Ambient Intelligence environment.

The present invention relates to a system, apparatus, and method for augmented reality glasses that enable an end-user programmer to visualize an Ambient Intelligence environment having a physical dimension such that virtual interaction mechanisms/patterns are superimposed over real objects and devices.

Ambient Intelligence is defined as the convergence of three recent and key technologies: ubiquitous computing, ubiquitous communication, and interfaces adapting to the user. “Ambient” is defined as “existing or present on all sides,” see, e.g., Merriam-Webster Dictionary. Ubiquitous is defined as “existence everywhere at the same time,” see, e.g., The American Heritage Dictionary, incorporating the concept of omnipresence of computing and communication in every environment including the home, workplace, a hospital, retail establishment, etc. Ubiquitous Computing means integration of microprocessors into everyday objects of an environment. In a home, these everyday objects include furniture, clothing, toys, and dust (nanotechnology). Ubiquitous Communication means these everyday objects are able to communicate with one another as well as living things in their proximity using ad-hoc wireless networking. And, all of this is accomplished unobtrusively

How does an end-user develop software applications for such an Ambient Intelligence environment when it is not feasible to replicate the target environment; and even when it is feasible, how are the invisible or virtual interconnections among intelligent devices and their relationships to living things (not just humans) in this environment made visible to an end-user developer?

Existing end-user programming techniques often use visual programming languages on a computer screen to allow a user to develop their own applications. However, these end-user programming techniques do not really work well for Ambient Intelligence environments where there is also a physical dimension. The visualization of the virtual and real dimensions in a way that can be readily understood by end-users and that is suitable for end-user programming is difficult using computer graphics alone. For example, an end-user developer can be an expert or a service employee in professional domains but might also be a consumer at home. Programming devices to do what the end-user wants should be as simple and convenient as rearranging furniture.

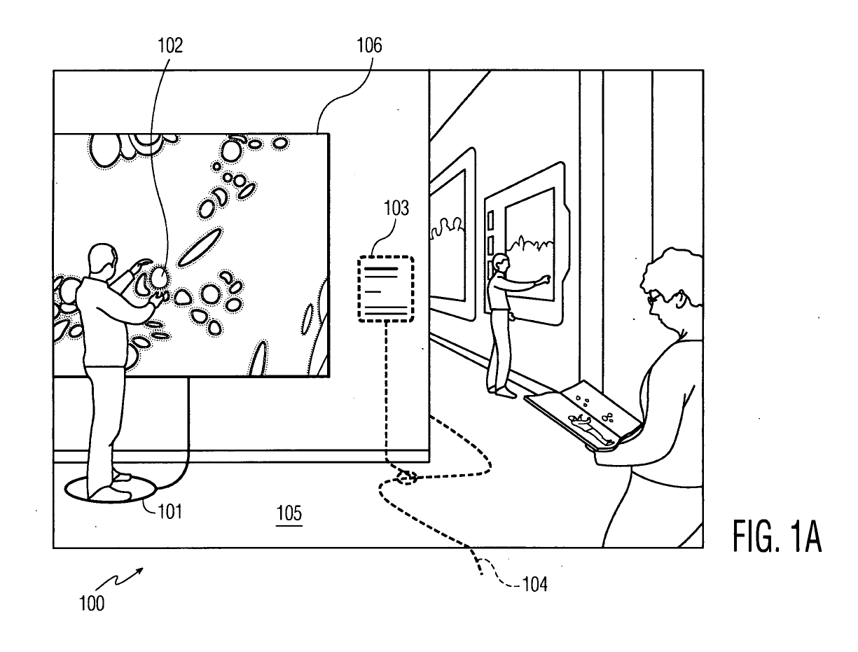

Referring now to FIGS. 1A-B, instead of visualizing the end-user's interaction with an Ambient Intelligence environment through a graphical user interface, a preferred embodiment of the present invention uses augmented reality (AR) glasses 131 through which the virtual interaction mechanisms/patterns (e.g., context triggers 101 102 and links between Ambient Intelligence applications) are superimposed over real objects 105 106 and devices.

When an end-user programmer views the Ambient Intelligence environment through the augmented reality (AR) glasses 131 the end-user is said to be in the “write” mode, i.e., the end-user can ‘see’ the existing relationships among Ambient Intelligence applications as embodied in real objects and devices. And when the end-user programmer is not wearing the augmented reality (AR) glasses 131, like all other end-users of an Ambient Intelligence environment, the end-user is said to be in the “read” mode because the relationships are no longer ‘visible’ and only their effects can be experienced.

Real experiences can be said to form in a subject-oriented, reflexive, and involuntary way. A user may choose the situation that the user is in (to some degree) but the situation always affects the user in a way the individual cannot control. The user “reads” the ‘text’ perceived through senses but also affects it (“writes”) by the user's actions. The current separation of reading and writing in an Ambient Intelligence environment is analogous to a separation between rehearsing and performing.

The system, apparatus, and method of the present invention provide an effective and efficient way for a user to develop applications for an Ambient Intelligence environment that is based on splitting up such an environment into component parts comprising small applications called “beats.” The user uses the augmented reality (AR) glasses 131 to develop these beats as well as to maintain and update them.

These beats are then arranged by an Ambient Narrative Engine 300 based on feedback from users of the Ambient Intelligence environment (usage in a specific context) to form a unique story line. That is, a set of beats is interrelated by users interacting with an Ambient Intelligence environment, e.g., by training the environment. This set of beats and their interrelationships can even be personalized to a given user by capturing transitions between beats and forms the user's own personal story of his Ambient Intelligence experience. This personal story is retained in a persistent memory of some kind and used by the Ambient Narrative Engine 300 to create the Ambient Intelligence environment in its future interactions with the particular user in a kind of interactive narrative/drama set in mixed reality. Alternatively, training can result from averaging multiple users' interactions over a training period and can also be updated, when needed.

In a co-creation embodiment, e.g., a performance environment, when an individual performs the performance itself causes new beats to be authored thereby and added to the ambient narrative thereby changing the structure and contents of the interactive narrative in real-time. A performer can either wear the AR glasses 131 while performing to ‘see’ the beats being authored while performing or can review the performance by wearing the AR glasses 131 and reviewing the beats generated by the performance, at a later time. The performer wearing the AR glasses 131 can interrupt a performance to ‘edit’ a beat as it is being authored, say, if the performer is dissatisfied with the performance and wants to repeat all or a part to achieve a different beat (or a modified beat).

As indicated above, on-going revisions to the narrative are possible, i.e., training and re-training of the Ambient Intelligence environment by adding/modifying/removing beats and interrelationships among them as well as modifying and adding transitions between beats. The augmented reality (AR) glasses 131 of the present invention facilitate the original development by making the beats and their transitions visible (visualization) as the environment is being exercised (authoring). Thereafter, the augmented reality (AR) glasses of the present invention perform a similar function for maintenance and enhancement (updates) of the deployed/developed Ambient Intelligence environment.

FIG. 1A illustrates a wearer's impression of an Ambient Intelligence environment using augmented reality (AR) glasses;

FIG. 1B illustrates an example of an implementation of augmented reality (AR) glasses;

FIG. 1C illustrates an example of an audio input/output device for AR glasses including a headset comprising earphones and a microphone;

FIG. 1D illustrates an example of a mobile mouse-like device for making selections in the field-of-view of the AR glasses of the present invention;

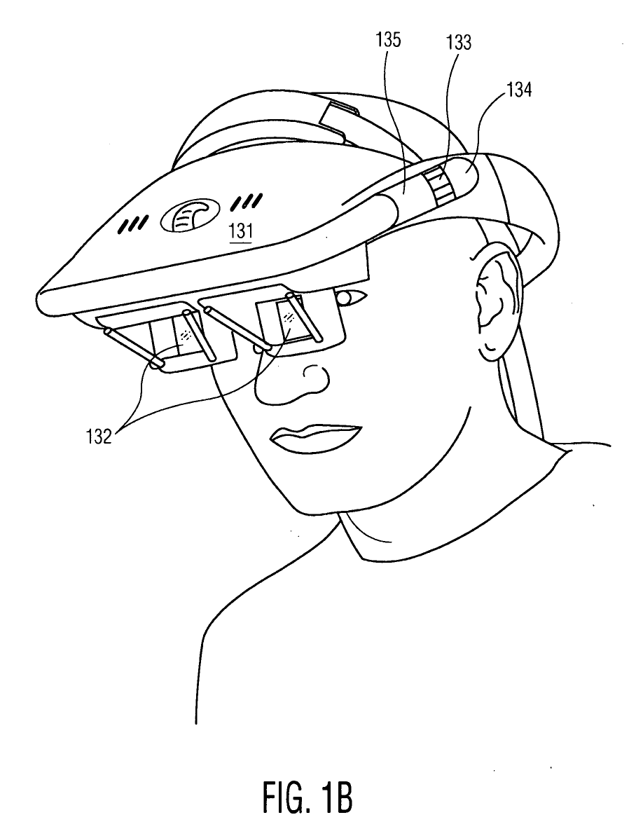

FIG. 2 illustrates a typical beat document;

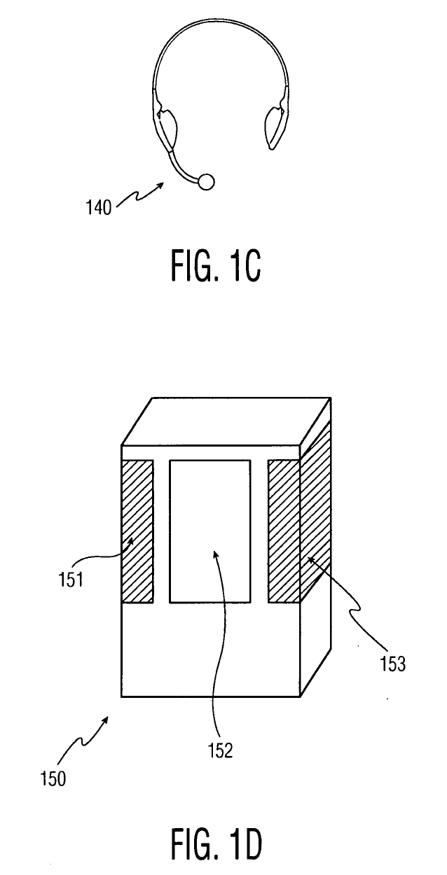

FIG. 3 illustrates a typical beat sequencing engine flowchart;

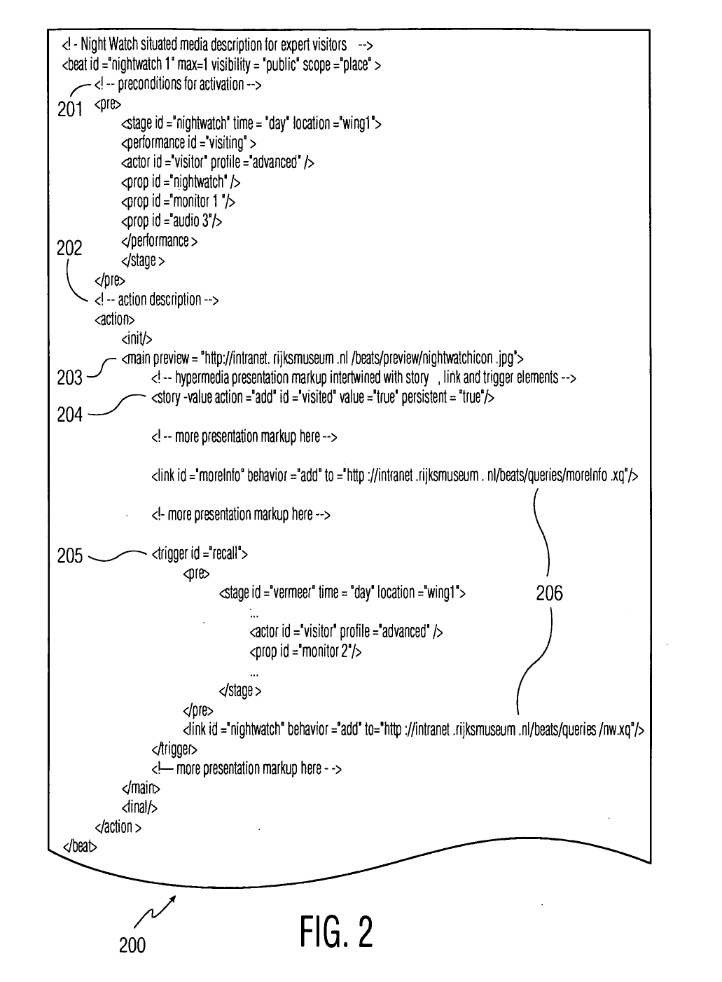

FIG. 4 illustrates a typical augmented reality system;

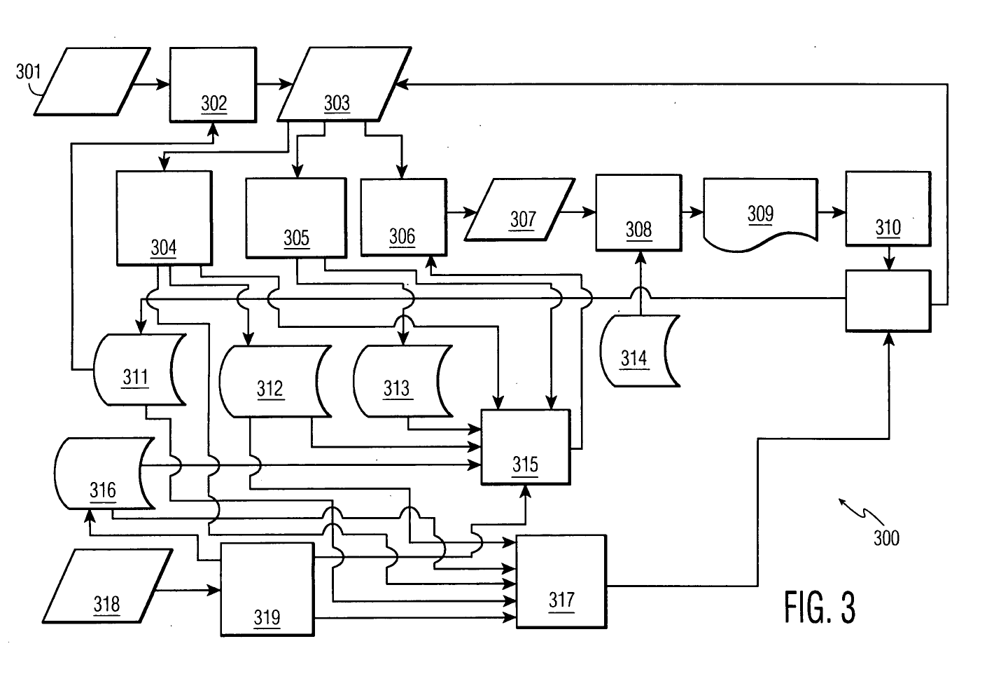

FIG. 5 illustrates the augmented reality system of FIG. 4 modified with an authoring tool, according to the present invention;

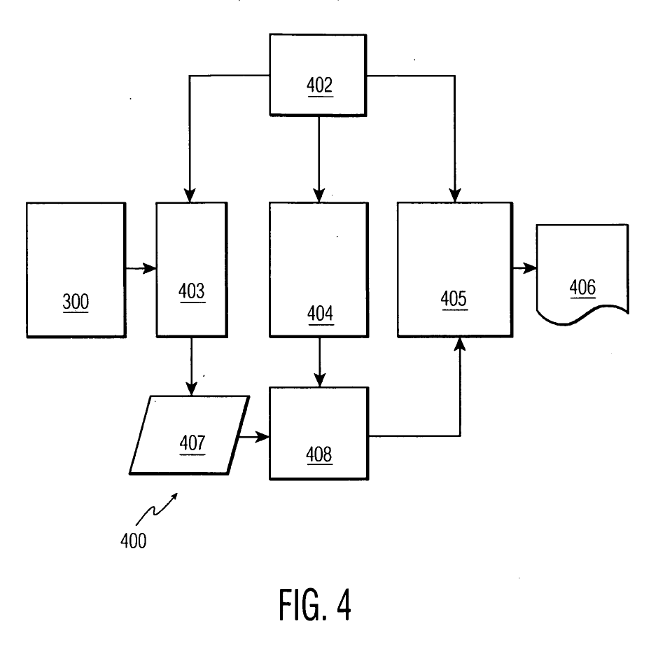

FIG. 6 illustrates screens of a beat authoring user interface using the AR glasses of the present invention;

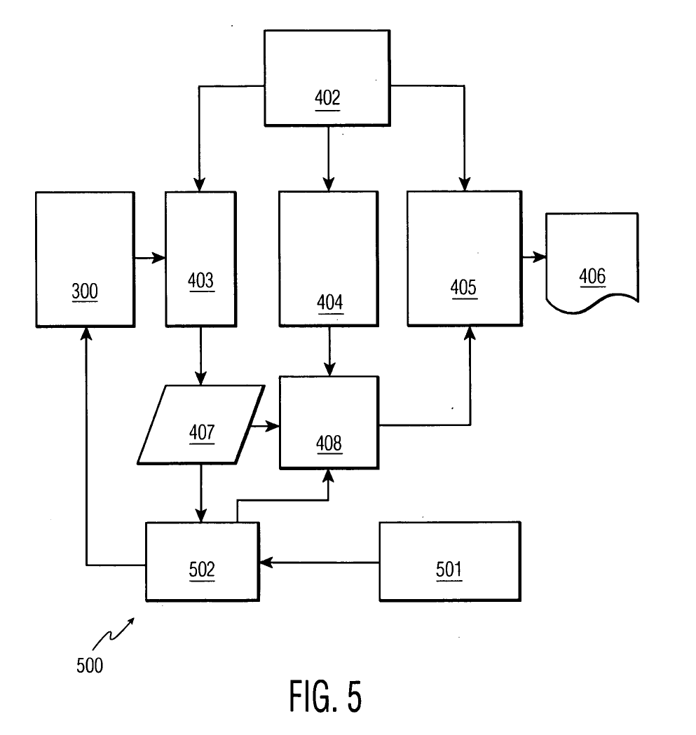

FIG. 7 illustrates a screen of a user interface using the AR glasses of the present invention for accomplishing link modification;

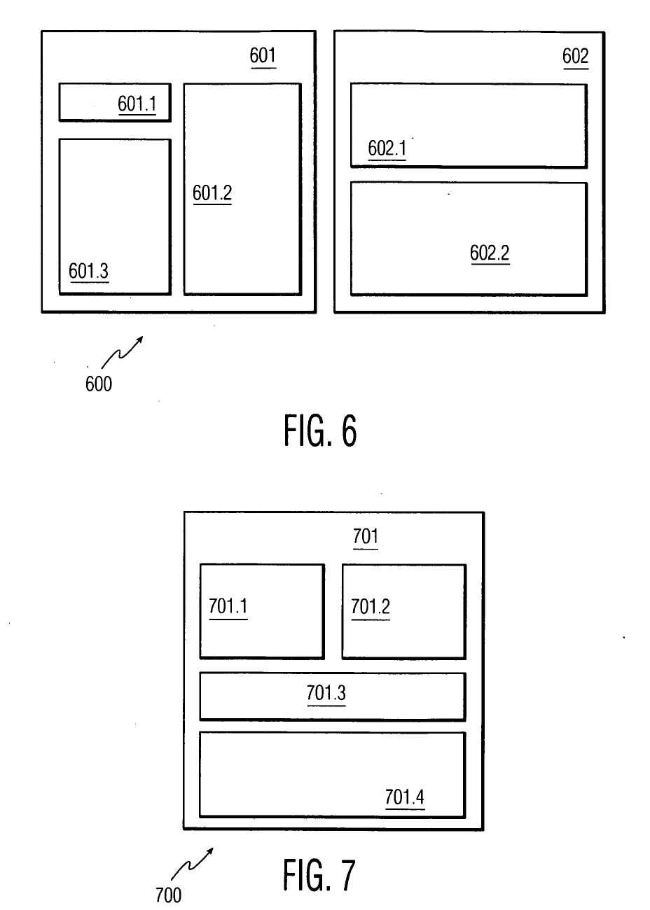

FIG. 8 illustrates screens of a user interface using the AR glasses of the present invention for precondition modification/definition;

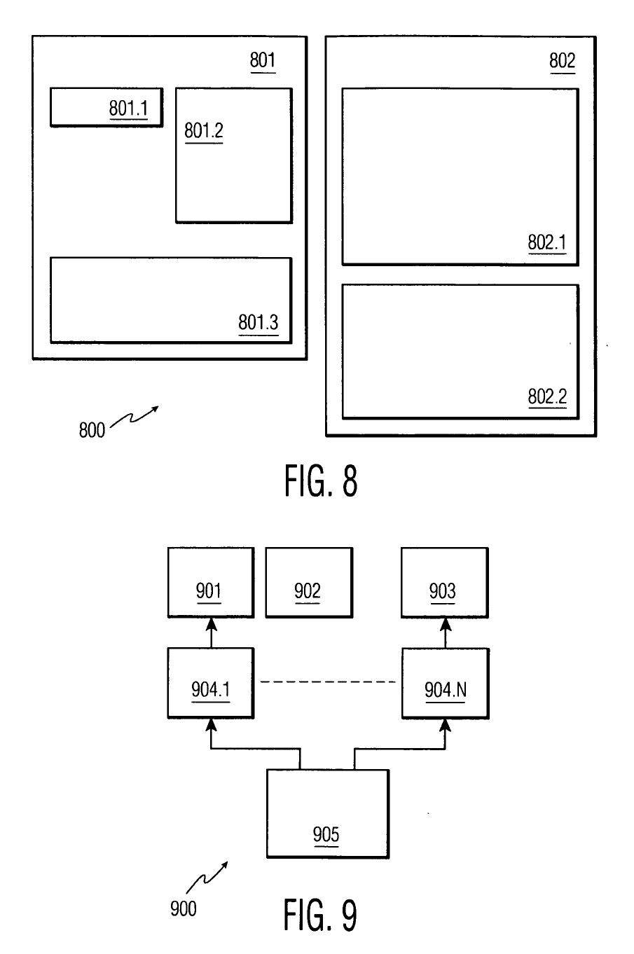

FIG. 9 illustrates adding a new beat to a plot structure;

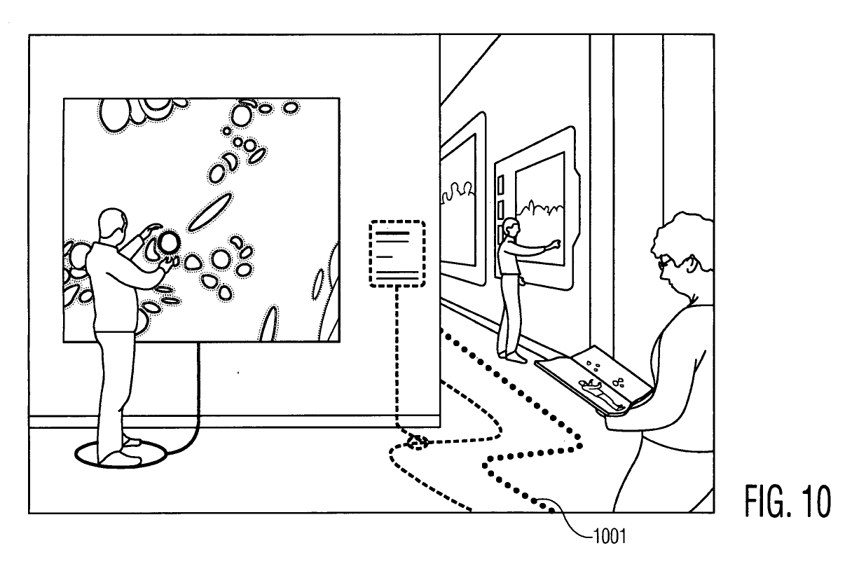

FIG. 10 illustrates how a newly added link appears in the field-of-view of the AR glasses; and

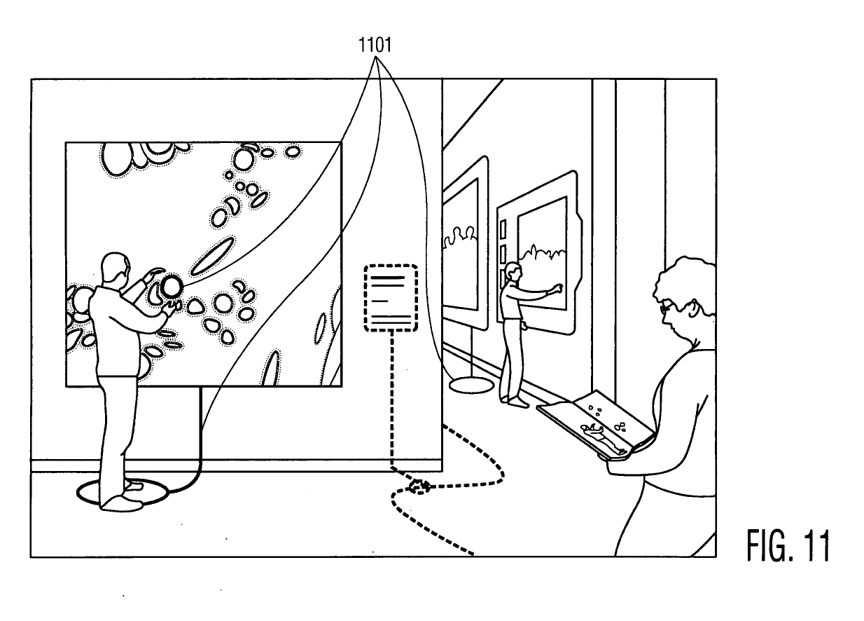

FIG. 11 illustrates beats that are affected by an “undo” operation.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

The system, apparatus, and method of the present invention provide augmented reality (AR) Glasses for user programming of an Ambient Intelligence environment. A scenario including an Ambient Intelligence environment where AR glasses are especially useful is:

1. Scenario

When ordinary visitors of an art museum walk through the rooms and halls of the museum they often have difficulty in understanding the paintings and their history. Situated digital media (text/images, music/speech and video) is provided for selected art objects that are tailored to the knowledge level of the visitor (beginner, intermediate, advanced or young/adult) and the art objects to be viewed in order to provide a better learning experience.

Consider the following user scenario: an Art Historian visits the Rijksmuseum in Amsterdam. When she enters the 17^{th} century Dutch hall she sees the famous painting of the “Night Watch” (1642) of Rembrandt van Rijn. When she walks up to the painting, text appears in a display next to the painting that shows many details of the painting and the golden age. The Art Historian is particularly interested in the sections on 17^{th} century portrait painting and the use of lighting. After a while, a message on the screen points her to the paintings of Johannes Vermeer. When the art historian approaches “the Milkmaid” (1658-1660), the story continues.

The Rijksmuseum Curator decides to add more situated media to the paintings and works of art in the museum. To view the triggers and media associated with the triggers, he wears augmented reality (AR) glasses 131. FIG. 1A illustrates an example of what the museum curator sees through his pair of augmented reality (AR) glasses 131. The purple circle on the ground 101 indicates an area where a user can trigger a media presentation (purple sphere 102). The dotted yellow line on the floor 104 indicates a link from one painting to another painting (focused on the use of lighting in portrait painting, for example). When the curator presses a button 151 on his AR glasses or on a mobile-mouse device (FIG. 1D) 150 in his pocket, a dialogue screen appears in his field-of-view 132 allowing him to manage situated media objects. He chooses to add a new media object to a painting. By walking around or setting the radius of interaction, the curator defines the area where the situated media object can be triggered. The curator sets the knowledge level of the visitor to ‘advanced’ and selects an appropriate media presentation from a list of such presentations displayed in the field-of-view 132 of the AR glasses 131, the corresponding presentations being stored in a museum database. An icon then appears on the display next to the painting 103. The curator stores the new situated media object and continues to add and update the works of art with media using the augmented reality (AR) glasses as an aid in ‘programming’ the media-to-art associations and triggers.

An implementation using AR glasses 131 according to the present invention is as follows:

2. Implementation

Architecture is regarded as an interactive narrative in a preferred embodiment of the present invention. Depending on the way a user walks through a building, a different story is told to the user. Augmented with digital media and lighting, the combined view of the architecture is an ambient narrative. By walking through (interacting with) the environment the user creates a unique personal story that is perceived as Ambient Intelligence. In the “read” mode, for visitors like the Art Historian, users can only experience what has already been programmed. In the “write” mode (activated by putting on the augmented reality (AR) glasses 131), authorized museum personnel can change the situated media in the ambient narrative.

The atomic units of an ambient narrative are called beats. Each beat consists of a pair comprising a preconditions part and an executable action part. The preconditions part further comprises at least one description of a condition selected from the group consisting of on stage (location), performance (activity), actor (user role), props (tangible objects and electronic devices) and script (story values including the knowledge level) that must be true before the action part can be executed. The action part contains an actual presentation description or application that is respectively rendered/launched in an environment whenever its preconditions are true. Beats are sequenced by a beat sequencing engine 300 based on user feedback (e.g., user commands/speech), contextual information (e.g., available users, devices) and state of a story.

FIG. 2 is an example of a beat document 200. It includes:

i. Preconditions 201 that must hold before the beat can be scheduled for activation. The stage element indicates for example that there must be a stage called “nightwatch” in a location named “wing1.” The actor element further states that there must be a visitor present who is known as ‘advanced’ (expert). The preconditions basically describe the situation in which the action can be allowed.

ii. Action taken when the preconditions are true. The main part 203 includes a hypermedia presentation markup, possibly containing navigation elements such as story-value 204, trigger 205, and link 206. These elements are used to specify how the action/application can affect the beat sequencing process. In FIG. 2 one of each type is shown, but there can be any number of each of them (or none at all) in a beat description.

As discussed above, in a preferred embodiment there are at least two interaction modes: the “read” mode and an authoring or the “write” mode.

The following steps are taken during normal use (read mode) of an Ambient

Intelligence environment:
Capturing context: Sensors continuously monitor the environment (one or more places) for changes in users, devices and objects. Several types of sensors may be used in combination with each other to populate a context model. The context information is needed by the beat sequencing engine to determine if the preconditions of a beat are valid.
Using one beat as the start beat (e.g., an ‘index.html’ page). This beat forms the entry point in the narrative. The action part is executed. The action part can contain presentation markup that can be sent to a browser platform or can contain a remote procedure call to a special application.
Locally handling user feedback (e.g., keyboard pressed, mouse clicked). When a beat markup element is encountered in the presentation markup or the application, the instruction is passed on to the beat sequencing engine 300 where it is checked against the beat set. If the element id and document id exist, the user feedback event (link, trigger set/unset, story value change) is handled by the beat sequencing engine 300. If, for example in FIG. 2, the link element is reached in the presentation, the query specified in the ‘to’ field will be executed. The resulting beat(s) will be added to the active beat set (if all its/their preconditions are valid).
Forwarding recognized changes in context (e.g., a new user enters the environment) by a sensor network to the beat sequencing engine 300.

An example of a flow diagram of a beat sequencing engine 300 is illustrated in FIG. 3. The use of links, triggers (delayed links; become activated when the preconditions of the trigger have been met) and story-values (session variables for narrative state information) results in a highly dynamic system.

In a preferred embodiment, a user authoring a “write” mode is triggered when an authorized user wears augmented reality (AR) glasses 131 when the user is in an Ambient Intelligence environment. In this mode, the beat sequencing engine 300 continues to function in the same way as in the “read” mode providing the user immediate feedback on his actions. However, in addition to the normal operation of the Ambient Intelligence environment, the authoring tool 502 visualizes metadata about the narrative in the user's field-of-view 132 of the augmented reality (AR) glasses 131. In FIG. 1A icon 103, path 104, and circle 102 indicate this extra information or metadata.
An icon 103 represents an action part of a beat. If the action part uses multiple devices, multiple icons appear for the beat. To indicate which icons belong to the same beat, colors or another visual feature is used, in a preferred embodiment.
A correspondingly combination-colored path 104 represents a link from one colored beat to another colored beat. The path's source and anchor beats are indicated by their color signatures: If the source beat has blue icons and the target beat red icons, the path is a blue/red dotted line, for example.
A correspondingly colored circle 102 or rectangle on the floor, wall or ceiling represents the location where a colored beat is active.

The extra information or metadata can be extracted out of the beat set by the beat sequencing engine 300:
In a preferred embodiment, each beat has a preview attribute (used for off-line simulation). This beat preview attribute is associated with an icon. Each device and object specified in the preconditions section of a beat document in the beat set is marked with this icon. Because the beat sequencing engine knows the position and location of devices and objects, the Augmented Reality system (see, e.g., FIGS. 4-5) can overlay the virtual icons on the real objects using the Augmented Reality glasses 131 the user is wearing and taking into account the user's orientation (using, e.g., the camera 402 of FIG. 4).
Links are specified in the action part of a beat description. A source and target of a link can be calculated. A stage precondition in each beat description is used to determine the path. In a preferred embodiment, when there is no direct line of sight a pre-stored physical plan of a building/location is used to calculate a route between beats and which route is made visible to the wearer of the AR glasses 131, see, e.g., 104.
An area where a beat is active is extracted out of a stage precondition in the beat description and a context model (exact coordinates). In a preferred embodiment, the Augmented Reality (AR) glasses of the present invention are used to overlay a virtual plane with a real wall or floor, for example.

FIG. 4 illustrates a flow of a typical Augmented Reality system 400. A camera 402 in a pair of Augmented Reality glasses 131 sends the coordinates of the user and his orientation to a data retrieval module 403. This data retrieval module 403 queries 307 a beat sequencing engine 300 in order to obtain the data (icons, paths and areas and the positional data in the context model of the beat sequencing engine) for a 3D model 407 of the environment. This 3D model 407 is used by a graphics-rendering engine 308 together with positional data from the camera 402 to generate a 2D plane that is augmented with the real view of the camera 405. The augmented video 406 is then shown to the user via the Augmented Reality glasses that the user is wearing.

The visualization of ambient narrative structure of the Ambient Intelligence environment from the user's point-of-view is a “read” capability provided by the Augmented Reality (AR) glasses 131 of the present invention. A “write” capability of the present invention further enables the user to change/program the Ambient Intelligence environment visualized using the Augmented Reality (AR) glasses 131. Preferably, as illustrated in FIG. 5, the present invention provides an authoring tool 502 and an interface to at least one user input device 131 140 150. The user input device includes a means for capturing gestures and a portable button-device/mobile-mouse 150 to select icons and paths in the 3D model of the augmented environment presented in the field-of-view 132 of the user wearing the Augment Reality glasses of the present invention.

A graphical user interface (GUI) 600-900 in the field-of-view 132 of the user is also provided, in a preferred embodiment, for selecting icons and paths that appear in the field-of-view 132 of a user wearing the AR glasses of the present invention. If the GUI does not fit on a single screen, a scrolling mechanism is provided to allow a user to move forward and backward in the multiple screen GUI. In a preferred embodiment, the scrolling mechanism is one of a scroll button of a mobile mouse, a scroll button on the AR glasses 131, or a voice command captured by the headset. Other possibilities include capturing user gestures, head nods, and other body movements as directions to scroll the display in the field-of-view 132 of the AR glasses 131 a user is wearing. In a preferred embodiment incorporating voice commands, spoken keywords are used as shortcuts to menus and functions and a speech recognizer activates on certain keywords and selects the corresponding menu and functions.

With the authoring tool 502 of the present invention, users can alter the structure of the ambient narrative. Changes made are committed to a beat database used by a beat sequencing engine 300 that generates the metadata presented in the field-of-view 132 of the wearer of the AR glasses 131 of the present invention. A graphics-rendering component 408, of an AR system 500 of a preferred embodiment, renders this GUI together with the augmented view. FIG. 5 illustrates a preferred embodiment of the relationships among the authoring tool 502, beat sequencing engine 300 and Augmented Reality system 402-408.

An authoring tool 502 for an Ambient Intelligence environment typically comprises:
Modifying beat actions, links and preconditions
Adding beats and links
Removing beats and links
   A typical authoring tool 502 allows users to add new bats and links, remove old ones and modify existing ones and these capabilities are provided in the “write” mode of the AR glasses 131. [0] In a preferred embodiment, the “read” mode can be entered at the direction of the user so that the user does not have to take off the AR glasses 131 to enter the “read” mode. In this “read” mode the user sees the extra information visualized in his AR glasses 131 but the Ambient Intelligence environment perform as if the user were in “read” mode without wearing the AR glasses. Also, in a preferred embodiment, trial beat sets can be named so that a trial set of beats can be saved and later added/removed as a set at one time. This avoids situations where a user forgets to remove a beat that is only used in combination with another beat that has been removed. This also enables reuse of previously defined and debugged beat sets, e.g., to provide another building with some Ambient Intelligence.

Other GUIs are possible, in alternative embodiments, in which different screens are selected and displayed in the field-of-view 132 of the AR glasses 131 by touching a button 151. Further, an alternative embodiment may use a speech dialogue and a headset 140. In all alternative GUI embodiments, the user receives immediate feedback on the user's actions.

By selecting icons, paths, and areas, in a preferred embodiment, a user brings up different authoring screens.

By selecting an icon, in a preferred embodiment, a user modifies the action part of a particular beat. An example is illustrated in FIG. 6 in which the first screen 601 provides information about the beat such as incoming and outgoing links 601.2. The second screen 602 allows the user to modify the icon. Both screens 601 602 appear in the field-of-view 132 of a user wearing the Augmented Reality glasses 131 of the present invention.

By selecting a path, a user can change 701 the source and/or target of a link 701.1/701.2 (FIG. 7). The user can select an existing beat from the beat database or specify a query 701.3 (e.g., by speaking a few keywords and then the icons of the beat that match the query keyword are shown in the icon).

By selecting an area, the user can change the preconditions 801 802 of the selected beat (FIG. 8).

Users may switch between authoring screens since when a user changes the preconditions of a beat the user may also want to change the effect it has and alter the action). The AR system 500 provides immediate feedback to the user. All changes are reflected in the visualization provided by the AR glasses 131 of the present invention.

To add a new beat, the user indicates that he wishes to add a new beat. In a preferred embodiment this is accomplished by pressing a button which brings up a mode in which the user can create the precondition and action part of the new beat. The preconditions must be specified first (as these will restrict the possible applications that can be chosen). By touching devices and objects, the user can add props to the precondition section of a new beat description. By wearing tagged clothing the user can assume actor roles and add actor restrictions. By walking around while pressing a button, in a preferred embodiment, the user sets the area where the beat can become active. Every interaction is as close to the physical world as possible. After the preconditions are set, the user selects a script or application that must be associated with the new preconditions. The final step is to add the new beat to the ambient narrative.

Referring now to FIG. 9, a basic structure is illustrated including a root beat (environment) 905 that has a fixed number of triggers (one for each place, e.g., a room in a museum). Each trigger causes a beat to be started for that particular place. This ‘place’ beat 904.1-904.N does nothing at first. But, when a user adds a new beat, the user can add the beat to a suitable ‘place’ beat 904.1-904.N (or just add the beat to the database for later use). This action is translated by the authoring tool 502 into a trigger element that is added to the right ‘place’ beat 904.1-904.N. A user is only allowed to remove beats that have been user-defined.

A trigger element has a preconditions part and a link description. If the preconditions have been met, the link is traversed (and the beat started). In a preferred embodiment, the 502 tool is simplified by restricting the allowed plot structures. To add a new link, the user must indicate by pressing a particular button that he wishes to add a new link. This is done, in a preferred embodiment, by using gestures in combination with a button press so that the user can select one icon as the to beginning point of the link and another icon as the end point of the link. The beginning point of the link brings up a dialogue screen in the field-of-view 132 in which the user specifies at which point in the script or application the link is to be traversed. When the user is satisfied the user saves the new link. The AR system provides immediate feedback to the user. New beats and links are immediately rendered in the field-of-view 132 of the Augmented Reality glasses 131. FIG. 10 illustrates how a newly added link appears in the field-of-view 132 of the AR glasses 131.

Removing beats and links is similar to adding beats and links: the user indicates removal by pressing a particular button or by means of a speech command. The user then selects an icon (by touching the physical object or device with his AR glasses still on) and he is warned that the beat (and all its outgoing links) will be removed. If the user selects a link in this mode he is likewise warned that the link will be removed. The AR system 500 provides immediate feedback to the user. Removed beats and links are removed from the field-of-view 132 of the Augmented Reality glasses 131. An “undo”/“debugging” mode is provided to allow a user to experiment with various configurations, i.e., removals of beats and links the effects thereof. The highlights 1101 in FIG. 11 illustrate beats 1001 that are affected by an “undo” operation as this operation is implemented in a preferred embodiment.

While the preferred embodiments of the present invention have been illustrated and described, it will be understood by those skilled in the art that the apparatus and system architecture and method as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling within the scope of the appended claims.

1. An apparatus (131 140 150) for an end-user to program an Ambient Intelligence environment to include at least one programmable component, comprising:
a pair of augmented reality (AR) glasses (131) having a see-through field-of-view (132) to visualize therein, for the end-user when wearing the AR glasses, the at least one programmable component proximate to a corresponding real world entity seen by the user in the see-through field-of-view;
a user programming interface (600-900) that appears in the field-of-view (132) of the AR glasses (131) of the end-user wearing the AR glasses for the end-user to view, create and modify at least one program for the at least one programmable component; and
at least one user input device (133-135 140 150) for a user to direct and react to the user programming interface (600-900) when it appears in the field-of-view (132).

2. The apparatus (131 140 150) of claim 1, wherein the AR glasses further comprise a capability to “read” the at least one programmable component as the end-user interacts with the Ambient Intelligence environment and display the end-user interaction with the Ambient Intelligence environment in the field-of-view as would be seen in the end-user without wearing the AR glasses (131).

3. The apparatus (131 140 150) of claim 1, wherein the user programming interface (600-900) is combined with the at least one user input device (133-135 140 150) and thereby comprises a capability to “write” that includes each of the following: create, retrieve and modify/delete, and name and store, individually and in combination any of icons (103), beats (200), areas (101) and links (104).

4. The apparatus (131 140 150) of claim 3, wherein the AR glasses (131) further comprise a capability to “read” the at least one programmed component as the end-user interacts with the Ambient Intelligence environment and display a view of the at least one component of the Ambient Intelligence environment as seen by the end-user.

5. The apparatus (131 140 150) of claim 1, wherein:
the user programming interface comprises a graphical user interface (600-900) presented in the field-of-view of the AR glasses (131); and
the user input device comprises a combination of devices selected from the group consisting of a headset for voice input/output (140); a button-device/mobile-mouse (150) including a left button (151) and a right button (153) and a menu button (152); a handheld audio input-output wand including a microphone and a speaker for voice input and audio feedback; wheel mouse incorporated in the AR glasses (133-135); and a left (135) and right (134) button incorporated into the AR glasses.

6. The apparatus (131 140 150) of claim 2, wherein, the user programming interface is combined with the at least one user input device and thereby comprises a capability to “write” that includes each of the following: create, retrieve and modify/delete, and name and store, individually and in combination any of icons (103), beats (200), areas (101) and links (104).

7. The apparatus (131 140 150) of claim 2, further comprising:
a means for providing information concerning the position and orientation of the end-user wearing the AR glasses to determine a scene being viewed by the user wearing the AR glasses (131); and
a means for acquiring component position information to visualize at least the corresponding real world entity proximate to the at least one component in the field-of-view (132).

8. The apparatus (131 140 150) of claim 7, wherein:
the means for providing information concerning the position and orientation of the end-user is a camera mounted in the AR glasses (131); and
the means for acquiring component position information is selected from the group consisting of a retrieving position information from a database of component positions and obtaining position information from a sensor network deployed to sense the components.

9. The apparatus (131 140 150) of claim 8, wherein, the user programming interface is combined with the at least one user input device and thereby comprises a capability to “write” that includes each of the following: create, retrieve and modify/delete, and name and store, individually and in combination any of icons (103), beats (200), areas (101) and links (104).

10. The apparatus (131 140 150) of claim 9, wherein:
the user programming interface comprises a graphical user interface (600-900) presented in the field-of-view of the AR glasses (131); and
the user input device is a combination of devices selected from the group consisting of a headset for voice input/output (140); a button-device/mobile-mouse (150) including a left button (151) and a right button (153) and a menu button (152); a handheld audio input-output wand including a microphone and a speaker for voice input and audio feedback; wheel mouse (133-135) incorporated in the AR glasses (131), and a left (135) and right (134) button incorporated into the AR glasses.

11. A system for end-user programming of an Ambient Intelligence environment comprising:
an augmented reality system (402-408) including:
i. a pair of augment reality (AR) glasses (131 402) according to claim 11 that are worn by an end-use; and
ii. a beat sequencing engine (300) to “read” programmable components of an Ambient Intelligence environment triggered by the end-user while wearing the AR glasses (131 402), wherein the triggered components are visualized in a field-of-view of the AR glasses (131 402) worn by the end-user,
an authoring tool (502) to collect end-user input an interfaced to the AR system (402-408) for an end-user to “write” the programmable components and associated programs of the Ambient Intelligence environment using a user-interface displayed in the field-of-view of the AR glasses (131 402).

12. A method for an end-user in an Ambient Intelligence environment to program the Ambient Intelligence environment to include at least one programmable component, comprising:
providing a pair of augmented reality (AR) glasses (131) having a see-through field-of-view (132);
when an end-user wears the AR glasses in the Ambient Intelligence environment, visualizing in the field-of-view, the at least one programmable component proximate to a corresponding real world entity seen in the see-through field of view;
displaying an end-user programming interface (600-900) in the field-of-view (132) that enables the end-user to “read” and “write” at least one program for the at least one programmable component having an “undo”/“debugging” mode; and
providing at least one user input device (133-135 140 150) for the end-user to direct and react to the displayed end-user programming interface (600-900) when it appears in the field-of-view (132) to program the at least one programmable component.

13. The method of claim 12, further comprising the steps of:
providing information concerning the position and orientation of the end-user wearing the AR glasses;
determining a scene being viewed by the end-user wearing the AR glasses (131) from the provided position and orientation information of the end-user; and
acquiring programmable component position information; and
visualizing the at least one programmable component in the field-of-view (132) proximate to the corresponding real world entity seen in the see-through field-of-view (132).

14. The method of claim 13, wherein:
the step of providing information concerning the position and orientation of the end-user further comprises the step of providing s a camera mounted in the AR glasses (131); and
the step of acquiring component position information further comprises the step of acquiring information from a source selected from the group consisting of a database of positions and a sensor network deployed to sense component positions.

15. The apparatus method of claim 14, further comprising the step of combining the steps of displaying the end-user interface with providing the at least one user input device in a step of “writing” a program for a programmable component wherein the step of “writing” comprises the substeps of creating, retrieving and modifying/deleting, and naming and storing, individually and in combination, any of icons (103), beats (200), areas (101) and links (104).

16. The method of claim 15, wherein:
the step of displaying an end-user programming interface further comprises the step of displaying a graphical user interface (600-900) presented in the field-of-view of the AR glasses (131); and
the step of providing a user input device further comprises the step of providing a combination of devices selected from the group consisting of a headset for voice input/output (140); a button-device/mobile-mouse (150) including a left button (151) and a right button (153) and a menu button (152); a handheld audio input-output wand including a microphone and a speaker for voice input and audio feedback, wheel mouse (133-135) incorporated in the AR glasses (131); and a left (135) and right (134) button incorporated into the AR glasses.
